(19) United States
(12) Patent Application Publication
(10) Pub. No.: US 2025/0010886 A1
(43) Pub. Date: Jan. 9, 2025

(54) CONTROL DEVICE FOR VEHICLE

(71) Applicant: Toyota Jidosha Kabushiki Kaisha, Toyota-shi (JP)

(72) Inventors: Fumihiro NASU, Nagoya-shi (JP); Wataru Minoura, Nagoya-shi (JP); Yoshiki Terashima, Okazaki-shi (JP); Yoshiaki Motoyasu, Nagoya-shi (JP)

(73) Assignee: Toyota Jidosha Kabushiki Kaisha, Toyota-shi (JP)

(21) Appl. No.: 18/680,371

(22) Filed: May 31, 2024

(30) Foreign Application Priority Data
Jul. 3, 2023 (JP) 2023-109664

(51) Int. Cl. B60W 60/00; B60W 50/10; B60W 50/14; G06V 20/59; G06V 40/16

(52) U.S. Cl. CPC B60W 60/0013; B60W 50/10; G06V 20/597; G06V 40/174; B60W 2050/146; B60W 2420/403; B60W 2540/22

(57) ABSTRACT

A vehicle includes an autonomous driving device and a navigation device. A control device for the vehicle is configured to display on the navigation device an evaluation window for evaluating a driver assistance function performed by the autonomous driving device. The control device is configured to adjust a parameter that is used when the autonomous driving device performs the driver assistance function, based on an input operation from a driver to the evaluation window.

### CROSS-REFERENCE TO RELATED APPLICATION

This application claims priority to Japanese Patent Application No. 2023-109664 filed on Jul. 3, 2023 incorporated herein by reference in its entirety.

### BACKGROUND

### 1. Technical Field

The present disclosure relates to control devices for vehicles.

### 2. Description of Related Art

In recent years, vehicles that can perform autonomous driving have been increasingly used.

Japanese Unexamined Patent Application Publication No. 2020-042642 (JP 2020-042642 A) discloses a driving evaluation device that estimates the riding comfort of an occupant based on the occupant's expressions and behaviors and evaluates driving of a vehicle controlled by autonomous driving.

### SUMMARY

Vehicles that can perform autonomous driving can perform various driver assistance functions. The driver assistance functions includes, for example, an automatic lane change function.

When a vehicle automatically changes lanes, how the driver of the vehicle takes the vehicle's behavior varies depending on the driver. For example, a driver who is not used to driving may feel scared by high acceleration at the time of the lane change.

However, the vehicle's behavior when performing a driver assistance function is the same for all the drivers.

It is an object of the present disclosure to make it possible to adjust a vehicle's behavior when performing a driver assistance function.

A control device for a vehicle according to the present disclosure is
a control device for a vehicle,
the vehicle including an autonomous driving device and a navigation device, and
the control device being configured to
display on the navigation device an evaluation window for evaluating a driver assistance function performed by the autonomous driving device, and
adjust a parameter that is used when the autonomous driving device performs the driver assistance function, based on an input operation from a driver to the evaluation window.

According to the present disclosure, it is possible to adjust a vehicle's behavior when performing a driver assistance function.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a vehicle according to an embodiment of the present disclosure;

FIG. 2 is a diagram illustrating an example in which a navigation device displays an evaluation window;

FIG. 3 is a diagram illustrating an example in which a navigation device displays a pop-up window;

FIG. 4 is a diagram illustrating another example in which the navigation device displays a pop-up window; and

FIG. 5 is a flowchart illustrating an operation of a vehicle according to an embodiment of the present disclosure.

### DETAILED DESCRIPTION OF EMBODIMENTS

Hereinafter, an embodiment of the disclosure will be described with reference to the drawings.

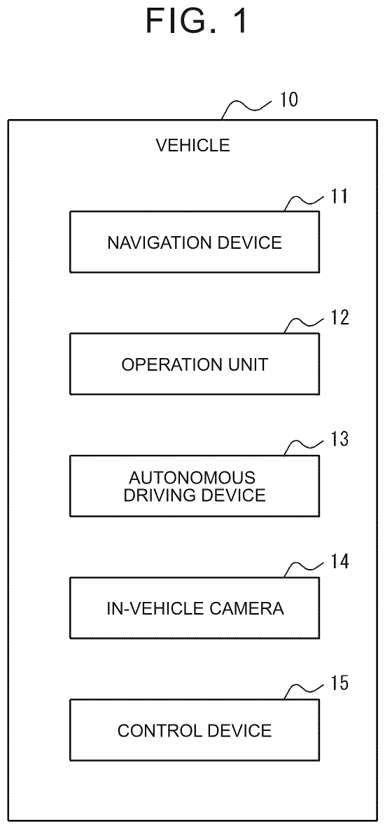

FIG. 1 is a diagram illustrating a configuration of a vehicle 10 according to an embodiment of the present disclosure. Referring to FIG. 1, a configuration and an outline of a vehicle 10 according to an embodiment of the present disclosure will be described.

The vehicle 10 is a vehicle that can perform autonomous driving. The vehicles 10 may be, for example, gasoline-powered vehicles, BEV (Battery Electric Vehicle), HEV (Hybrid Electric Vehicle), PHEV (Plug-in Hybrid Electric Vehicle), or FCEV (Fuel Cell Electric Vehicle). Driving of the vehicle 10 may be automated at any level. The level of automation may be, for example, any of level 1 to level 5 of Society of Automotive Engineers (SAE).

The vehicle 10 includes a navigation device 11, an operation unit 12, an autonomous driving device 13, an in-vehicle camera 14, and a control device 15.

The navigation device 11 is a device that guides a route of the vehicle 10. For example, the navigation device 11 comprises a Global Positioning System (GPS) receiver, a communication module, input interfaces, memories, processors, and displays. GPS receiver acquires the position of the vehicles 10 based on the signals received from GPS satellites. The communication module receives traffic information. The input interface receives an input operation of the driver. The memory stores any information used for the operation of the navigation device 11. For example, the memory stores map information, traffic information, location information of the vehicle 10, location information of a destination, and the like. The processor controls the overall operation of the navigation device 11. For example, the processor performs a process of route guidance of the vehicle 10, and displays a processing result on a display.

The operation unit 12 receives an instruction from the driver to the vehicle 10. The operation unit 12 may be, for example, a direction indicator, a button provided near the driver's seat of the vehicle 10, or the like. For example, when the vehicle 10 performs a predetermined driver assistance function, the vehicle 10 may start performing the predetermined driver assistance function based on an operation of the driver on the operation unit 12.

The autonomous driving device 13 is a device that performs autonomous driving of the vehicle 10. For example, the autonomous driving device 13 includes one or more in-vehicle sensors, a memory, and a processor. Examples of the in-vehicle sensor include a camera, a millimeter wave radar, a rider, a steering wheel steering angle sensor, and a vehicle speed sensor. The memory stores arbitrary information used for the operation of the autonomous driving device 13. The memory stores, for example, a parameter that is used when the autonomous driving device 13 performs the driver assistance function. The processor controls the overall operation of the autonomous driving device 13. For example, the processor performs a process of autonomous driving of the vehicle 10 by using the detection result from each in-vehicle sensor. Specifically, the processor performs steering control, accelerator control, brake control, and the like of the vehicle 10.

The in-vehicle camera 14 captures an image of a driver of the vehicle 10. The in-vehicle camera 14 transmits the captured image to the control device 15. The image captured by the in-vehicle camera 14 may be a still image or a moving image.

The control device 15 is a device that controls the navigation device 11, the autonomous driving device 13, and the like. The control device 15 may be, for example, an Electronic Control Unit (ECU). The control device 15 includes, for example, a communication module, a memory, and a processor. The communication module can communicate with the navigation device 11, the operation unit 12, the autonomous driving device 13, and the in-vehicle camera 14. The memory stores arbitrary information used for the operation of the control device 15. The processor may control the navigation device 11 and the autonomous driving device 13.

### Operation of the Vehicle

The operation of the vehicle 10 shown in FIG. 1 will be described with reference to FIG. 1 to FIG. 4.

As described above, the vehicle 10 is a vehicle that can perform autonomous driving. The autonomous driving device 13 performs autonomous driving of the vehicle 10. The autonomous driving device 13 can perform various driver assistance functions as autonomous driving functions of the vehicle 10.

The driver assistance functions that can be performed by the autonomous driving device 13 include, for example, an automatic lane change function, an automated passing function, and an automatic collision avoidance function.

The autonomous driving device 13 may start the driver assistance function in response to an operation on the operation unit 12 by the driver. Alternatively, the autonomous driving device 13 may automatically start the driver assistance function even if the driver does not operate the operation unit 12.

For example, when the driver assistance function is the automatic lane change function or the automated passing function, the autonomous driving device 13 starts the driver assistance function in response to an operation on the operation unit 12 by the driver.

For example, when the driver assistance function is the automatic collision avoidance function, the autonomous driving device 13 automatically starts the driver assistance function even if there is no operation on the operation unit 12 by the driver.

The navigation device 11 can cause the navigation device 11 to display an evaluation window for the driver to evaluate the driver assistance function performed by the autonomous driving device 13.

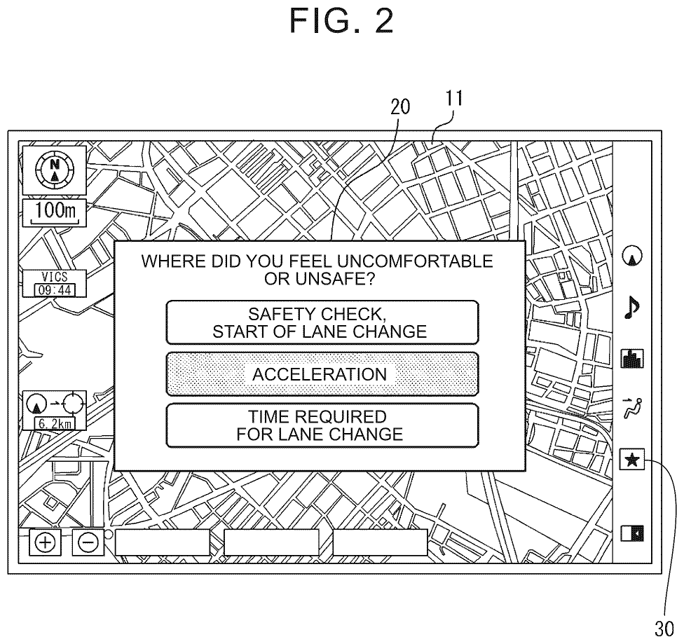

FIG. 2 illustrates an example in which the navigation device 11 displays the evaluation window 20.

The navigation device 11 may display an evaluation button 30 for displaying the evaluation window 20. When the driver presses the evaluation button 30 displayed by the navigation device 11, the control device 15 causes the navigation device 11 to display the evaluation window 20.

The evaluation window 20 is a display for the driver to evaluate the driver assistance function performed by the autonomous driving device 13. The content displayed in the evaluation window 20 is content according to the type of the driver assistance function performed immediately before the evaluation window 20 is displayed. That is, the content displayed in the evaluation window 20 varies between when the driver assistance function performed immediately before the evaluation window 20 is displayed is the automatic lane change function and when the driver assistance function performed immediately before the evaluation window 20 is displayed is the automated passing function.

FIG. 2 shows an example in which the evaluation window 20 is displayed immediately after the autonomous driving device 13 performs the automatic lane change function.

In the example shown in FIG. 2, the evaluation window 20 indicates a question in which “where did you feel uncomfortable or anxious?, and three items in which “safety check, start of lane change”, “acceleration”, and “time required for lane change”.

The control device 15 adjusts a parameter that is used when the autonomous driving device 13 performs the driver assistance function based on an input operation from the driver to the evaluation window 20.

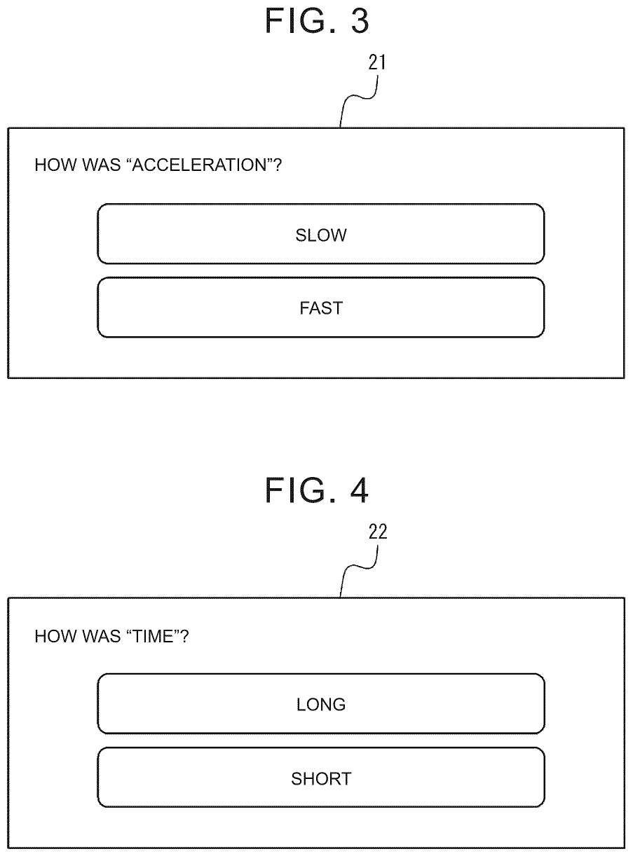

FIG. 3 is a diagram illustrating an example of the pop-up window 21 displayed on the navigation device 11 when the driver selects “acceleration” in the evaluation window 20 illustrated in FIG. 2. FIG. 4 is a diagram illustrating an example of the pop-up window 22 displayed on the navigation device 11 when the driver selects “time required for lane change” in the evaluation window 20 illustrated in FIG. 2.

When the driver selects “slow” in the pop-up window 21 shown in FIG. 3, the control device 15 increases a parameter for the acceleration in the automatic lane change function by a predetermined value. When the driver selects “fast” in the pop-up window 21 shown in FIG. 3, the control device 15 reduces the parameter for the acceleration in the automatic lane change function by a predetermined value.

When the driver selects “long” in the pop-up window 22 shown in FIG. 4, the control device 15 adjusts the values of various parameters in the automatic lane change function so as to reduce the time required for lane change. When the driver selects “short” in the pop-up window 22 shown in FIG. 4, the control device 15 adjusts the values of the various parameters in the automatic lane change function so as to increase the time required for lane change.

The control device 15 adjusts the parameter within a range between an upper limit value and a lower limit value, both inclusive. For example, in the automatic lane change function, the parameter of acceleration includes a settable upper limit value and a settable lower limit value. The control device 15 adjusts the parameter within a range between the upper limit value and the lower limit value, both inclusive, when adjusting the acceleration parameter of the automatic lane change function.

As described above, the control device 15 adjusts the parameters that are used when the autonomous driving device 13 performs the driver assistance function, based on the input operation from the driver to the evaluation window. As a result, the driver can adjust the behavior of the vehicle 10 when the driver assistance function is performed to his or her preference. For example, when the acceleration at the time of lane change is fast and the user feels anxiety, the parameter of the acceleration at the time of lane change can be reduced by selecting “fast” in FIG. 3.

### Displaying the Evaluation Window Based on the Driver's Expression

In the above-described embodiment, a case has been described in which, when the driver presses the evaluation button 30 displayed by the navigation device 11, the control device 15 causes the navigation device 11 to display the evaluation window. However, the control device 15 may cause the navigation device 11 to automatically display the evaluation window based on the expression of the driver.

The in-vehicle camera 14 captures an expression of a driver of the vehicle 10.

When the autonomous driving device 13 performs the driver assistance function, the control device 15 analyzes the expression of the driver in the image captured by the in-vehicle camera 14 while the driving assistance function is being performed.

When it is determined that the analyzed expression of the driver is an expression representing a predetermined emotion with respect to the driver assistance function, the control device 15 causes the navigation device 11 to automatically display an evaluation window. The expression representing a predetermined emotion may be, for example, an expression representing anxiety, an expression representing fear, and an expression representing an uncomfortable feeling.

Accordingly, even if the driver does not press the evaluation button 30 displayed by the navigation device 11, the control device 15 can automatically display the evaluation window on the navigation device 11 based on the expression of the driver. Therefore, the driver can easily adjust the parameters of the driver assistance function when he or she feels unsafe, feels scared, or feels uncomfortable.

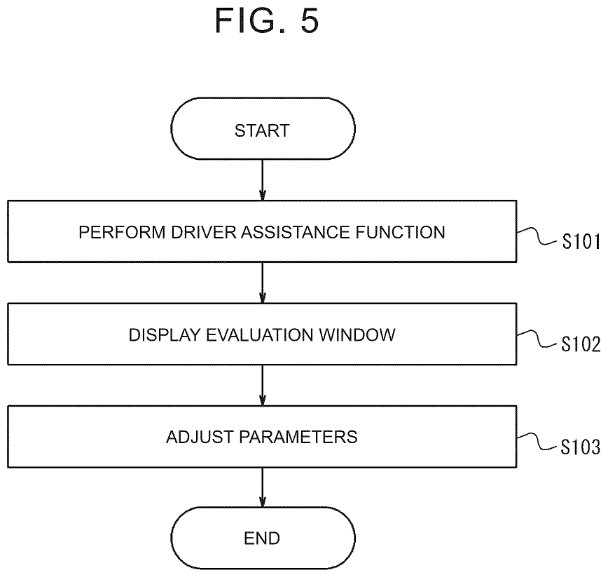

The operation of the vehicle 10 will be described with reference to the flowchart shown in FIG. 5.

The autonomous driving device 13 performs the driver assistance function either in response to an operation from the driver to the operation unit 12 or automatically (S101).

When the driver presses the evaluation button 30 displayed by the navigation device 11, the control device 15 causes the navigation device 11 to display the evaluation window (S102). Alternatively, the control device 15 analyzes the expression of the driver captured by the in-vehicle camera 14 while the driver assistance function is being performed. When it is determined that the analyzed expression of the driver is an expression representing a predetermined emotion with respect to the driver assistance function, the control device 15 causes the navigation device 11 to automatically display the evaluation window (S102).

Based on the input operation from the driver to the evaluation window, the control device 15 adjusts parameters when the autonomous driving device 13 performs the driver assistance function (S103).

As described above, in the vehicle 10 according to the present embodiment, the control device 15 causes the navigation device 11 to display an evaluation window for evaluating the driver assistance function performed by the autonomous driving device 13. The control device 15 adjusts the parameters when the autonomous driving device 13 performs the driver assistance function based on the input operation from the driver to the evaluation window. The control device 15 can thus acquire the evaluation of the driver about the driver assistance function and adjust the behavior of the vehicle 10 during the driver assistance function to the driver's preference. For example, when the driver of the vehicle 10 is not good at driving, the control device 15 can adjust the behavior of the vehicle 10 when the driver assistance function is performed to such a behavior that the driver feels neither scared nor unsafe.

The present disclosure is not limited to the embodiment described above. For example, a plurality of blocks shown in the block diagram may be integrated, or a single block may be divided into a plurality of blocks. Instead of performing the steps shown in the flowcharts in chronological order according to the description, the steps may be performed in parallel or in a different order, depending on the processing capacity of the device that performs the steps, or as necessary. Other changes may be made without departing from the scope of the present disclosure.

For example, some processing operations that are performed by the navigation device 11 in the above embodiment may be performed by the autonomous driving device 13 or the control device 15. In the above embodiment, part of the processing operations that are performed by the autonomous driving device 13 may be performed by the navigation device 11 or the control device 15. In the above embodiment, part of the processing operations that are performed by the control device 15 may be performed by the navigation device 11 or the autonomous driving device 13.

For example, it is also possible to configure a general-purpose electronic device such as a computer to function as the control device 15 according to the above-described embodiment. Specifically, it is conceivable that a program describing the content of processing for implementing each function of the control device 15 etc. according to the embodiment is stored in a memory of an electronic device, and the program is read and executed by a processor of the electronic device. Thus, the disclosure according to the embodiment can also be implemented as a program that can be executed by the processor.

A part of the embodiment of the present disclosure is shown as an example below. However, it should be noted that embodiment of the present disclosure is not limited to these.

### APPENDIX 1

A control device for a vehicle,
the vehicle including an autonomous driving device and a navigation device, and
the control device being configured to
display on the navigation device an evaluation window for evaluating a driver assistance function performed by the autonomous driving device, and
adjust a parameter that is used when the autonomous driving device performs the driver assistance function, based on an input operation from a driver to the evaluation window.

### APPENDIX 2

In the control device according to Appendix 1,
the control device is configured to display the evaluation window on the navigation device when the driver presses an evaluation button displayed on the navigation device.

### APPENDIX 3

In the control device according to Appendix 1 or 2,
the vehicle further includes an in-vehicle camera configured to capture an image of the driver, and
the control device is configured to
when the autonomous driving device performs the driver assistance function, analyze an expression of the driver in the image captured by the in-vehicle camera, and
when determination is made that the expression of the driver is an expression representing a predetermined emotion toward the driver assistance function, display the evaluation window on the navigation device.

### APPENDIX 4

In the control device according to any one of Appendices 1 to 3,
the control device is configured to display, in the evaluation window, content according to a type of the driver assistance function performed immediately before the evaluation window is displayed.

### APPENDIX 5

In the control device according to any one of Appendices 1 to 4,
the control device is configured to adjust the parameter within a range between an upper limit value and a lower limit value, both inclusive.

What is claimed is:

1. A control device for a vehicle, the vehicle including an autonomous driving device and a navigation device, and the control device being configured to
display on the navigation device an evaluation window for evaluating a driver assistance function performed by the autonomous driving device, and
adjust a parameter that is used when the autonomous driving device performs the driver assistance function, based on an input operation from a driver to the evaluation window.

2. The control device according to claim 1, wherein the control device is configured to display the evaluation window on the navigation device when the driver presses an evaluation button displayed on the navigation device.

3. The control device according to claim 1, wherein
the vehicle further includes an in-vehicle camera configured to capture an image of the driver, and
the control device is configured to
when the autonomous driving device performs the driver assistance function, analyze an expression of the driver in the image captured by the in-vehicle camera, and
when determination is made that the expression of the driver is an expression representing a predetermined emotion toward the driver assistance function, display the evaluation window on the navigation device.

4. The control device according to claim 1, wherein the control device is configured to display, in the evaluation window, content according to a type of the driver assistance function performed immediately before the evaluation window is displayed.

5. The control device according to claim 1, wherein the control device is configured to adjust the parameter within a range between an upper limit value and a lower limit value, both inclusive.
